(19) United States
(12) Patent Application Publication
(10) Pub. No.: US 2018/0158134 A1
(43) Pub. Date: Jun. 7, 2018

(54) Shopping System Using Augmented Reality

(71) Applicant: Abdelrahman Hassan, Fremont, CA (US)

(72) Inventor: Abdelrahman Hassan, Fremont, CA (US)

(73) Assignee: Abdelrahman Hassan, Fremont, CA (US)

(21) Appl. No.: 15/832,270

(22) Filed: Dec. 5, 2017

Related U.S. Application Data
(60) Provisional application No. 62/497,849, filed on Dec. 5, 2016.

(51) Int. Cl. G06Q 30/06; G06F 17/30; G06K 9/00

(52) U.S. Cl. CPC G06Q 30/0643; G06Q 30/0623; G06F 17/30876; G06T 19/006; G06K 9/00671; H04N 13/0271; G06F 17/3087

(57) ABSTRACT

A shopping system using augmented reality is disclosed. The shopping system comprising; a camera to capture the picture of a product; a computer vision program to recognize the identity of the product; a GPS to detect the location of the camera; a database that associates each identity of a product with commercial information related to the product and the product location; and a display to present the commercial information of the product based on the camera location once the picture is captured.

### CROSS-REFERENCE TO RELATED APPLICATION

This application claims the benefits of a U.S. Provisional Patent Application No. 62/497,849, filed Dec. 5, 2016.

### BACKGROUND

With the speed of online commerce still purchasing from malls or stores has many advantages over online shopping. For example, in stores, people can try and check the products before buying them. They can feel the weight, texture or size of most product before using it. Such information cannot be gathered when shopping online. On the other hand, online shopping has a major advantage over stores purchasing which is allowing the comparison of different available prices of the same products at the same time. This is achieved by visiting various websites that sell the same product so that online shoppers can compare between the product prices before placing an online order. In such a case, usually online shoppers use a web search engines such as GOOGLE or BING search engines, or visit an Internet-based retailer store such as AMAZON.

However, until now there has been no technology that enables stores buyers to get real time information about the product they are buying, including prices of the same or similar products in other stores. Also, there has been no technology that allows online shoppers to check or touch a product before buying it online. In fact, if such a technology is invented it will change the way people buy and sell products in stores and online. Therefore, it will dramatically allow people to spend and save money wisely.

### SUMMARY

The present invention discloses a shopping system that has the advantages of purchasing from stores and online at the same time using an object recognition technique. Consequently, the user becomes aware of the product prices at different stores once they see the product in a store or mall. In this case, the user can order the product from any store after seeing, touching, or physically checking the product at the store they are visiting. This way, the user can compare the product prices in real time to get the best deal, knowing exactly what they are buying before paying.

This is achieved by using an object recognition technique with a digital camera of an electronic device such as a mobile phone, tablet, or optical head-mounted display. For example, a product buyer in a store can use the camera of a mobile phone to capture the product picture and view the product prices in other local stores or online. This allows the user to compare the prices and select the store that offers a better price for the same produce. Also, in this case, the user can place an online order for the product once they reach a better online price after seeing the product or try it in a local store. Accordingly, there are no surprises after receiving the order since the user already checked the product before receiving it.

The same technique can be used when buying online. In this case, the user can take a picture of a product on the computer screen to view a list of local stores that sell the same product. This list will be associated with the product price at each store. The user can then visit a local store to physically see and check the product before ordering it online or buying it from any other store based on the price offered. Also, the user can directly buy the product from the local store if it offers a better price. In case the local store can deliver the product, the user calls the store and places an order for the product to receive it at home. The user can take a picture of the product on the computer display using a mobile phone, or can take a screen capture of the product using a computer program without using a camera.

Generally, the present invention achieves many advantages for the buyers and sellers that are not available with current shopping methods or systems. For example, the user can get information related to the prices and availability of any product they are seeing in a store, home, or street by taking a picture of that product. This product can vary from an electronic device displayed in a store to a piece of furniture in a home, or a car seen in a street. Thus, the buyer can get the best price for the product they are intending to purchase, saving the time to locate the product at local stores. Moreover, the user can have access to see the product before placing an online order which eliminates the time and money wasted in returning products that do not match the buyer's expectation. For the seller, the local stores can compete with online retail stores by giving information to local neighbors about the products they have. This dramatically increases the stores sales and gives them a competitive advantage over online stores.

Technically, the present invention discloses a shopping system comprising; a camera to capture the picture of a product; a computer vision program to recognize the identity of the product; a GPS to detect the location of the camera; a database that associates each identity of a product with commercial information related to the product and the product location; and a display to present the commercial information of the product based on the camera location once the picture is captured.

In one embodiment, the camera is a digital camera of an electronic device such as a mobile phone, tablet, or optical head-mounted display. In another embodiment, the camera is a depth sensing camera that senses the distances of the exterior surface points of the product relative to the camera position, creating a 3D model of the product. In case of using a digital camera, the object recognition program is a computer vision program that identifies the objects located in 2D pictures as known in the art. In case of using a depth sensing camera, the object recognition program is a computer vision program that identifies the 3D models of objects located in point cloud files. The database is an online database accessible to each electronic device equipped with the camera. The display is a screen of en electronic device such as a mobile phone, tablet, or head-mounted computer.

In one embodiment, the database can be created and updated by various means. For example, each store can upload the database with the pictures and prices of their products. Also, the user can update the database with the pictures and prices of the products they find at different stores. In such cases, the GPS of the electronic device of the camera detects the location or store of the product that appears in pictures to be stored in the database with the product identity, price, and store name or location. In another embodiment, the database is an online database of a search engine such as GOGGLE or BING search engines. Once the user takes a picture of a product at a store the picture is sent to the online search engine to retrieve the online stores where the product is available.

### BRIEF DESCRIPTION OF DRAWINGS

FIG. 1 illustrates an optical head mounted display viewing a carpet in a hallway where the present invention displays various prices of the same carpet available at different local stores.

FIG. 2 illustrates a tablet screen viewing a bed where the present invention displays various prices of the same bed available at different local stores.

FIG. 3 illustrates a mobile phone screen viewing a product box where the present invention displays various prices of the product available at different physical and online stores.

FIGS. 4-6 illustrate the graphical user interface of the present invention to access different stores and prices for the same product.

### DETAILED DESCRIPTION

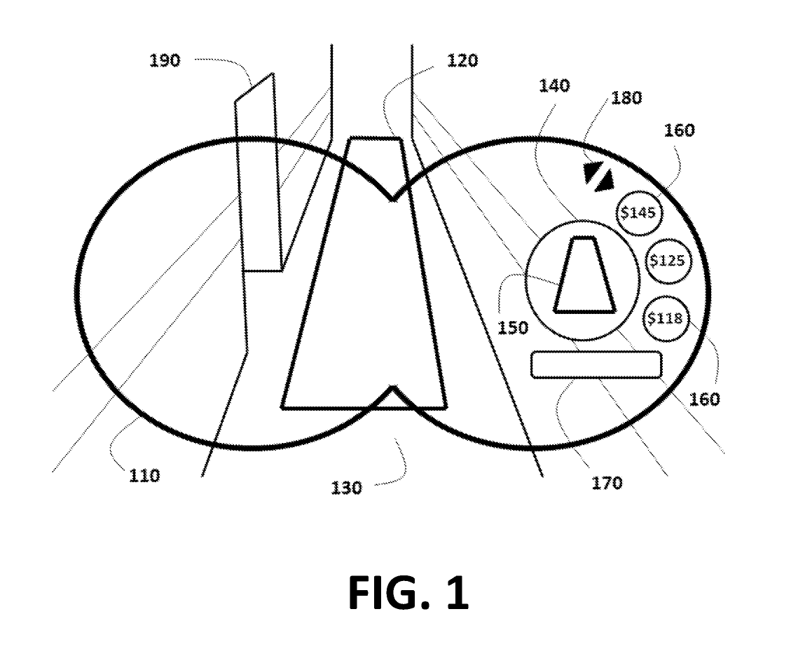

The present invention allows the user of an electronic device such as a mobile phone, tablet, or optical head mounted display (OHMD) to view commercial information related to the objects they are seeing indoors or outdoors. For example, FIG. 1 illustrates an optical head-mounted display (OHMD) 110 equipped with the present invention to present commercial information related to the objects located in front of the user. As shown in the figure, the user is looking at a carpet 120 located on a floor 130 of a hallway. A main window 140 appears on a side of the OHMD presenting the picture of the carpet 150, and a plurality of small windows 160 appears near the main window presenting different prices of the carpet available at local stores. The information window 170 located near the main window presents additional information related to the carpet such as its size, dimensions, material, or the like. The navigation arrows 180 allow the user to view more price options of the carpet available at other stores. As shown in the figure, multiple objects may appear in front of the user such as the door 190. In this case, the present invention only retrieves commercial information related to the object located in the center of the OHMD which represents the gaze line or line of sight of the user.

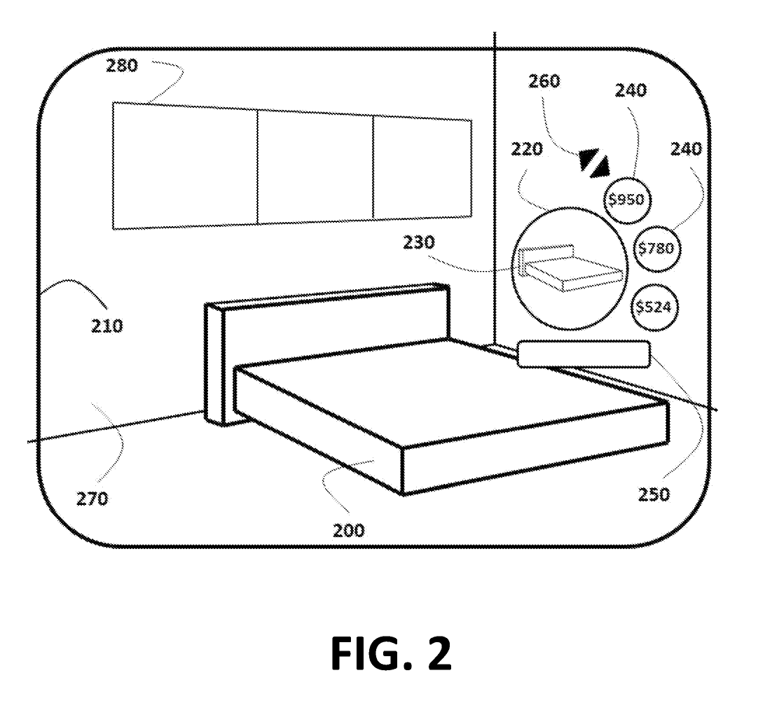

FIG. 2 illustrates viewing a bed 200 on a tablet display 210 using a digital camera. The main window 220 appears on the tablet display presenting the picture 230 of the bed, and the plurality of small windows 240 presents different prices of the bed available at various local stores. The information window 250 located near the main window presents information related to the bed such as its style, dimensions, and material. The navigation arrows 260 allow the user to view more prices or stores that sell the same bed. As shown in the figure, a wall 270 and a window 280 appear in front of the user where the present invention only presents commercial information related to the bed which is located near the center of the tablet display.

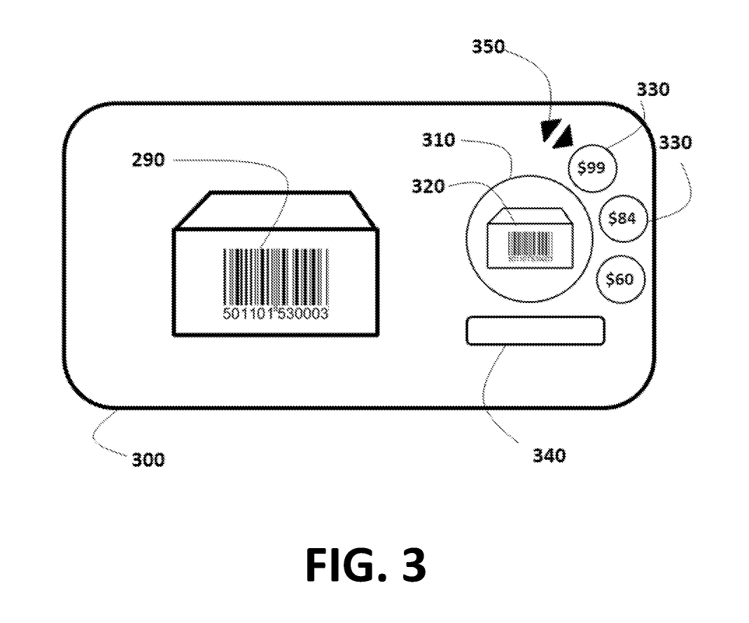

FIG. 3 illustrates viewing a product box with a barcode 290 using a screen 300 of a mobile phone equipped with a digital camera. The main window 310 appears on the screen with a picture of the product box and the barcode 320, and the plurality of the small windows 330 displays different prices of the product available at various local stores. The information window 340 located near the main window presents information related to the product such as its weight, material or the like. The navigation arrows 350 allow the user to view more prices of the same product available at other stores. In this example, the present invention recognizes the product by the barcode printed on the box. In another example, the present invention recognizes the product by the text printed on the box such as the product name, description, and company information. In a different example, the present invention recognizes the product from the picture printed on the box.

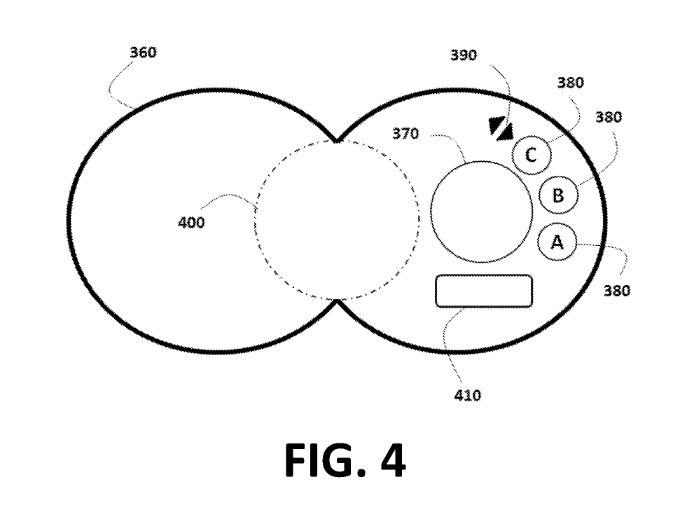

FIG. 4 illustrates a graphical user interface (GUI) of the present invention presented on an optical head-mounted display 360 according to one embodiment. As shown in the figure, the GUI is comprised of a main window 370 to present the picture of the product, and a plurality of small windows 380 to present the prices of the product available at different stores. The two navigation arrows 390 allow the user to view additional prices at other stores. The user can move the small windows forward or backward using one of the two navigation arrows. The central zone 400, located at the middle of the OHMD, is the zone where the product or object is recognized. Once the product or object appears in the central zone, the user provides the present invention with an immediate input to initiate the recognition process. The information window 410 presents additional information related to the product as was described previously.

In one embodiment, the user's input is in the form of a vocal instruction comprised of one or more words such as “Start the Search” or “Get Price”. In this case, the present invention utilizes a speech-to-text program to convert the user's speech into text representing a request for starting the search process. In case of using a mobile phone or tablet, an icon presented on the mobile phone or tablet screen can be selected to initiate the search process. Presenting the search output on the small windows can be done in various ways, for example, the prices can be presented from the lowest to the highest. Also, the prices can be presented according to the closest stores to the user's location which can be detected by the GPS of the OHMD, mobile phone, or tablet.

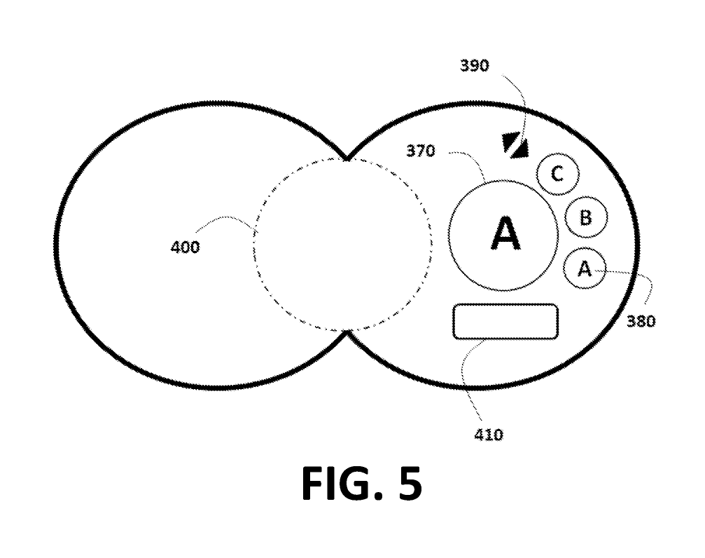

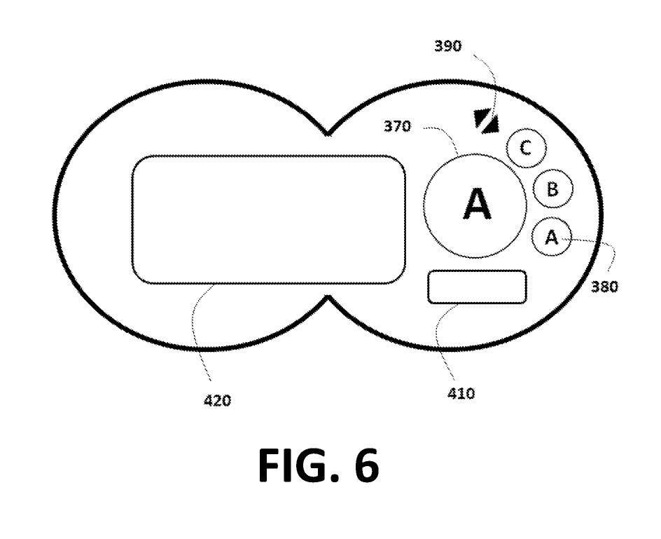

As shown in the previous figure, the small windows represent three different prices of the product A, B and C. Once the user selects one of the small windows, using vocal instructions, the main window presents the product picture of the selected small window. At this moment, the information window presents additional information related to the product of the selected price. The additional information may include a store name, location, phone number, or website. If the user needs to view the additional information on a bigger area of the OHMD, the user can provide vocal instructions to the present invention requesting that. FIG. 5 illustrates presenting the picture of the small window “A” on the main window 370 according to the user's selection using vocal instructions. Also, FIG. 6 illustrates presenting the additional information of the information window 410 on a bigger window or area 420 according to the user's request using vocal instructions.

According to the previous description, the present invention discloses a commerce system comprising; The shopping system comprising; a camera to capture the picture of a product: a computer vision program to recognize the identity of the product; a GPS to detect the location of the camera; a database that associates each identity of a product with commercial information related to the product and the product location; and a display to present the commercial information of the product based on the camera location once the picture is captured.

In one embodiment, the camera is a digital camera of an electronic device such as a mobile phone, tablet, computer, or optical head mounted display. In this case, the computer vision program is an object recognition program that detects the identity of the object presented in the picture of the digital camera. In another embodiment, the camera is a depth sensing camera that scans the exterior surfaces of the product creating a point cloud data file representing a 3D model of the product. In this case, the computer vision program is a 3D recognition program that detects the identity of the 3D models of the objects.

The database associates each identity of a product with information related to the product such as prices and stores names, location, or contact information. The database can be created and updated be the seller and users. For example, the seller can take a picture of each product available in the store and upload it to the database with information about the product price and description. The user can also update the database by taking a picture of any product in a store and upload it with its price. The GPS of the user's electronic device can detect the location of the product or store when taking the picture. The product can be any object such as a piece of furniture used in a home, a car parked in a street, or a device displayed in a store. The product can also be a product presented on online retail store on the computer. In this case, the picture of the product is taken by a software program installed on the computer, or taken by a digital camera of the user's mobile phone.

Generally, the present invention discloses a shopping system that has the advantages of purchasing from both physical and online stores at the same time. This is achieved by giving information to the user describing the availability of the product on different physical and online stores once the picture of the product is captured. Accordingly, the user can order the product from any store after seeing, touching, and physically checking the product at the store they are visiting. This way, the user can compare the product prices in real time to get the best deal, knowing exactly what they are buying before ordering or paying.

The same technique can be used when shopping online. In this case, the user can take a picture of a product on the computer screen to view a list of local stores that sell the same product with the product price at each store. The user can visit a local store to see and check the product physically before ordering it online. Also, the user can directly buy the product from a local store if it has better price. If the local store can deliver the product, the user calls the store and places an order for the product to receive it at home. The user can take a picture of the product on the computer display using a mobile phone, or can take a screen capture for the product using a computer program without the need for using a camera.

Overall, the present invention achieves many advantages for the buyers and sellers that are not available with current shopping methods and systems. For example, the user can get information related to the prices and availability of any product they are seeing in a certain store on online. Moreover, the user becomes able to check the product they are buying before the purchase. That eliminates the user's time and money wasted in returning products that do not match the user's expectation. For the sellers, the local stores can compete with online stores by providing real time information to local neighbors about the products they have. That dramatically increases the physical stores sales and gives them a competitive advantage over online retail stores.

1. A shopping system comprising:
a camera to capture a picture of a product;
a computer vision program to recognize the identity of the product presented in the picture;
a GPS to detect the location of the camera;
a database that associates each identity of a product with commercial information related to the product and the stores that sell the product; and
a display to present the commercial information of the product based on the camera location once the picture is captured.

2. The shopping system of claim 1 wherein the camera is a digital camera of an electronic device.

3. The shopping system of claim 1 wherein the camera is a depth sensing camera that detects the distances between the depth sensing camera and the points of the exterior surfaces of the product.

4. The shopping system of claim 1 wherein the commercial information includes the prices of the product available at different physical and online stores.

5. The shopping system of claim 1 wherein the camera and the GPS are incorporated into a single electronic device such as a mobile phone.

6. The shopping system of claim 1 wherein the display presents the available products available at nearest stores of the camera location.

7. The shopping system of claim 1 wherein the camera and GPS are incorporated into a mobile phone, tablet, or optical head-mounted display.

8. The shopping system of claim 2 wherein is the computer vision program is an object detection program that detects the identity of the two-dimensional objects that appear in pictures.

9. The shopping system of claim 3 wherein is the depth sensing camera generates a file contains data representing the three-dimensional model of the product

10. The shopping system of claim 9 wherein is the computer vision program detects the identity of the three-dimensional objects that appear in the file.

11. A shopping system comprising:
a computer program to capture a picture of a product presented on a display of a computer;
a computer vision program to recognize the identity of the product presented in the picture;
a GPS to detect the location of the computer;
a database that associates each identity of a product with commercial information related to the product and the stores that sell the product; and
a presentation program to present the commercial information of the product on the computer display based on the camera location once the picture is captured.

12. The shopping system of claim 1 wherein the computer program is installed on the computer.

13. The shopping system of claim 1 wherein the UPS is incorporated into the computer.

14. The shopping system of claim 1 wherein the GPS is a computer program that detects the location of the computer based on the Internet connection service of the computer.

15. The shopping system of claim 1 wherein the commercial information includes the prices of the product available at different physical and online stores.

16. The shopping system of claim 1 wherein the presentation program presents the products available at nearest stores of the computer location.

17. The shopping system of claim 1 wherein the computer vision program is a computer program that recognizes the product information associated with the image of the product presented on the display.

18. The shopping system of claim 1 wherein the computer program is a digital camera of an electronic device to capture the picture of the product image presented on the computer display.

19. The shopping system of claim 18 wherein the GPS is incorporated with the electronic device.

20. The shopping system of claim 19 wherein the electronic device is a mobile phone, tablet, or optical head-mounted display.
